(19) United States
(12) Patent Application Publication
(10) Pub. No.: US 2025/0238829 A1
(43) Pub. Date: Jul. 24, 2025

(54) MACHINE LEARNING TECHNIQUES FOR GENERATING PREDICTIONS FOR A TRANSACTION

(71) Applicant: PROS, INC., Houston, TX (US)

(72) Inventors: Mohit Mahajan, Westford, MA (US); Yan Xu, Houston, TX (US); Wenshen Song, Houston, TX (US); Royce Kallesen, Friendswood, TX (US); Jerry Guan, Sugarland, TX (US); Manu Chaudhary, Houston, TX (US); Zhaoyang Zhang, Richmond, TX (US); Chih-Hsien Wu, Sugarland, TX (US); Yuanyuan Liu, Missouri City, TX (US); Jonas Rauch, Mannheim (DE)

(21) Appl. No.: 18/419,146

(22) Filed: Jan. 22, 2024

(51) Int. Cl. G06Q 30/0201

(52) U.S. Cl. CPC G06Q 30/0206

(57) ABSTRACT

Techniques for training a price prediction model are disclosed. An example method includes receiving historical transaction data comprising a plurality of transactions, each transaction comprising a plurality of attributes and a transaction price. The method also includes processing the historical transaction data to generate training data comprising features extracted from the plurality of attributes and price indices generated from the transaction price. The method also includes training, by a processing device, a price prediction model using the training data, wherein training the price prediction model comprises training a neural network to generate a mapping between the features and the price indices, and wherein the features used to train the neural network are not segmented and correspond with a plurality of products, product types, geographies, and customer sizes.

### TECHNICAL FIELD

Aspects of the present disclosure relate to machine learning techniques for generating predictions for a transaction based on historical transaction data.

### BACKGROUND

Optimization may be pertinent to many aspects of the operation of an organization. For instance, an organization may desire to optimize gross revenue, net revenue, profit, sales volume, etc. These goals change from time to time, as circumstances suggest, and may apply to the entire organization, a subdivision of the overall organization such as a subsidiary, a division, a department, a product line, individual products, etc. These same goals may be directed toward particular customer segments based on demographic data, or other geographic, income, age, or other distinctions in the customer population.

Organizations involved in negotiated transactions may be able to maximize profit over time by developing an optimized pricing strategy. This may involve generating pricing predictions for negotiated transactions based on historical transaction data. Accurate pricing predictions may help the organizations to develop a pricing strategy that provides a more optimal balance between profit margin and the rate of success for winning contracts. Optimizing prices in this way can help the organization to maximize profit over time.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram of an example of a computer system in accordance with some embodiments of the present disclosure.

FIG. 2 is a block diagram of a model training system in accordance with some embodiments of the present disclosure.

FIG. 3 is a block diagram of a request handler 116 in accordance with some embodiments of the present disclosure.

FIG. 4 is an illustration of an example a price prediction model in accordance with some embodiments of the present disclosure.

FIG. 5 is a process flow diagram summarizing a method of generating price predictions without data segmentation, in accordance with some embodiments of the present disclosure.

FIG. 6 illustrates a diagrammatic representation of a machine in the example form of a computer system within which a set of instructions, for causing the machine to perform any one or more of the methodologies discussed herein, may be executed.

### DETAILED DESCRIPTION

The present disclosure relates to machine-learning techniques for generating pricing recommendations for negotiated transactions using historical transaction data. Such pricing recommendations may be generated through the analysis of historical transaction data in attempt to predict the expected product price for a future transaction. Conventional systems for generating pricing recommendations usually divide historical transaction data into customer segments (e.g., geographic regions, customer annual revenue buckets) and product segments (e.g., product groups, product lifecycle status, product quality, etc.). This type of data segmentation can be used to partition the large set of a company's transactions into much smaller sets of transactions. each of which can be assumed to be homogenous (e.g., same or similar product, product features, geography, etc.). Each segment can then be analyzed for pricing differences within that smaller partitioned data set to identify opportunities for better pricing.

However, partitioning data into a smaller segments and analyzing these segments separately can lead to data sparsity. Sparsely populated segments may present a poor the signal-to-noise ratio which could lead to misleading results, inaccurate predictions, and poor pricing recommendations. To protect against the negative effects of data sparsity, the partitioning process may be limited so that the data is partitioned over a limited number of data features. Limiting the number of features reduces the probability that the segmented set of transactions will not be homogenous. Therefore, the downstream processes that assume homogeneity can have problems with accuracy and making pricing recommendations that are appropriate for that negotiation.

Additionally, if segments are analyzed separately, the information in one segment may not be able to inform the analysis of a different segment. This may lead to missed opportunities to detect pricing effects that may be happening at a more macro level across segments, such as seasonality effects or longer-term market trends.

Pricing systems are often implemented using databases that process the data in a single large machine. Many of these pricing systems require data to be present in memory which can limit the amount of data that can be processed due to hardware limitations. To get around this limitation, many pricing systems pre-compute price recommendations for combinations of potential future transactions and store the pre-computed recommendations to a database for future retrieval in response to future transaction requests. While this process can provide prices for a set number of potential transactions, it very likely will not cover all transactions and it also cannot cover changes in the marketplace that happen between the time of pre-computing these price recommendations and when those prices are needed. An example of a marketplace change that could take place is the cost of a product. Because of supply issues, replacement costs may change significantly in a short period of time. This could impact the optimal price that is recommended and lead to suboptimal prices that are used in the transaction's negotiation.

Embodiments of the present disclosure address the above-noted and other deficiencies by providing a system that uses an improved modeling technique to generate pricing recommendations without the use of data segmentation. In accordance with embodiments described herein, one or more pricing models may be generated by training an artificial intelligence model or other type of machine learning model such as an artificial neural network. The pricing model may be trained on a body of training data derived from a large corpus of transaction data. Because the training data is not segmented (for example, to focus in on a particular product, geography, or customer), data sparsity on the pricing model is avoided, leading to more reliable and accurate results. Additionally, the trained model can be applied to various types of pricing requests regardless of the product, product features, geography, etc. Because the data used to train the model is not segmented, price predictions generated by the model may better reflect broader purchasing insights such that pricing predictions may include influences attributable to other product types, other geographical regions, other customers, and the like, that would not normally be present within the same segment. Accordingly, the present techniques provide a broader perspective that can capture influences such as seasonality and long-term trends.

Additionally, certain customers may tend to execute transactions at different price levels compared to the overall market. Some customers may have a tendency to pay over market prices while other customers may tend to pay under market prices. A system in accordance with embodiments, may be configured to generate both a customer-specific price recommendation and a market price recommendation to identify these two types of customers.

Embodiments of the present techniques may be implemented using a distributed computing system that breaks the data into smaller chunks and processes data on a cluster of machines rather than one large machine. This allows the system to scale as needed and process large amounts of data very quickly. This provides the ability to obtain real time pricing recommendations rather than pre-computing recommendations for a limited combination of possible transactions. Additionally, using a single machine learning model across all segments is more memory efficient than segmentation-based approaches, because segmentation-based might require access to the full training data set to make a prediction. By contrast, the price prediction model disclosed herein uses less memory and can be loaded onto multiple machines to make predictions in real-time regardless of the size of the training data.

In some embodiments, the pricing recommendation generated by the system may be used by the client in a negotiated transaction. For example, the client may use the price recommendation in a bidding process or a sales negotiation. In other examples, the pricing recommendation generated by the system may serve as a guide that the client can use to determine an actual price to use in the negotiation. For example, if the client has confidence in the customer relationship or the skill of the salesperson or team conducting the negotiation, the client may decide that a higher price is justifiable. In some embodiments, the price recommendations may be used to estimate the probability of successfully negotiating a transaction given a price used in the negotiation.

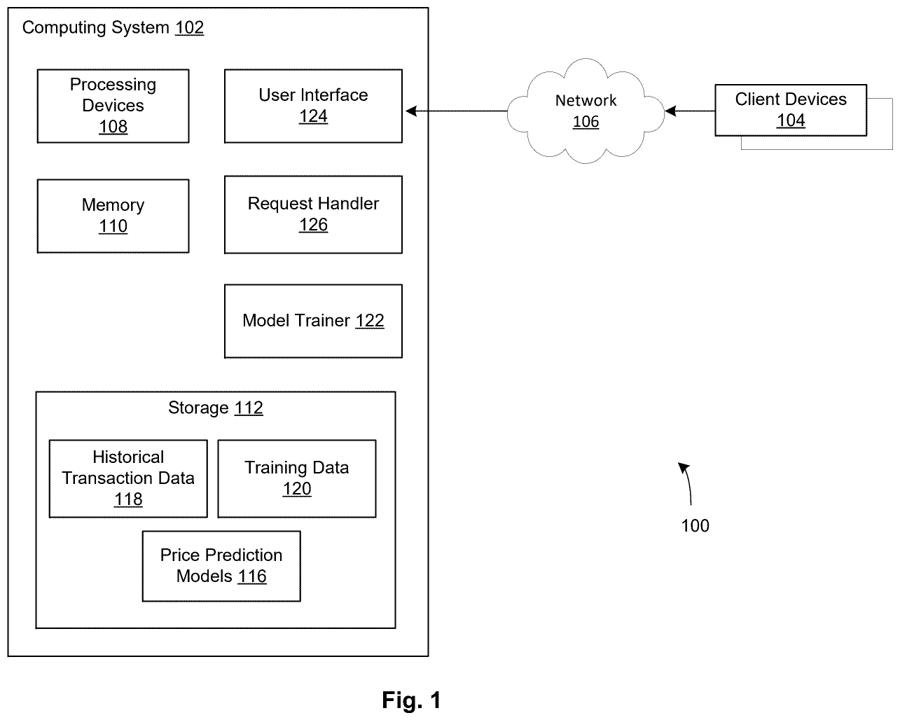

FIG. 1 is a block diagram of an example system 100 in accordance with some embodiments of the present disclosure. One skilled in the art will appreciate that other architectures are possible for system 100 and any components thereof, and that the implementation of a system utilizing examples of the disclosure are not necessarily limited to the specific architecture depicted by FIG. 1. The system 100 may include a computing system 102, which may be coupled to client devices 104 through a network 106. The computing system 102 may be a cloud-based infrastructure configured, for example, as Software as a Service (SaaS) or Platform as a Service (PaaS). In some embodiments, the computing system 102 may be distributed computing system with multiple compute nodes and memory nodes that can be scaled to serve a particular service or application in response to changing workload conditions. The computing system 102 may also be a non-cloud-based system such as a personal computer, a server, one or more servers communicatively coupled through a network, and other configurations.

Each client device 104 may be any suitable type of computing device or machine that has a programmable processor including, for example, server computers, desktop computers, laptop computers, tablet computers, smartphones, etc. In some examples, each of the client devices 104 may include a single machine or multiple interconnected machines (e.g., multiple servers configured in a cluster).

The network 106 may be a public network such as the Internet, a private network such as a local area network (LAN) or wide area network (WAN)), and combinations thereof. In some embodiments, the network 106 may include a wired and/or wireless infrastructures provided by one or more wireless communications systems, such as a WiFi hotspot connected with the network 106 and/or a wireless carrier system that can be implemented using various data processing equipment, communication towers (e.g. cell towers), etc. In some embodiments, the network 106 may be an L3 network. The network 106 may carry communications (e.g., data, message, packets, frames, etc.) between the computing system 100 and the client devices 104.

The computing system 102 can include one or more processing devices 108, memory 110, and storage 112 used to implement the techniques described herein. The processing devices may include central processing units (CPUs), graphical processing units (GPUs), application specific integrated circuits (ASICs), and other types of processors. The memory 110 serves as the main memory or working memory used by the processing devices 108 to store data and computational results. The memory 110 may include volatile memory devices such as random-access memory (RAM), non-volatile memory devices such as flash memory, and other types of memory devices. In certain implementations, main memory 110 may be non-uniform access (NUMA), such that memory access time depends on the memory location relative to processing device 108. Storage 112 may a persistent (e.g., non-volatile) storage device or system and may include one or more magnetic hard disk drives, Peripheral Component Interconnect (PCI) solid state drives, Redundant Array of Independent Disks (RAID) systems, a network attached storage (NAS) array, and others. The storage device 112 may be configured for long-term storage of data and programming used to implement the techniques described herein. It will be appreciated that the processing device 108, memory 110, storage 112 may each represent a monolithic/single device or a distributed set of devices. For example, the processing devices 108, memory 110, and/or storage 112 may each include a plurality of units (e.g., multiple compute nodes, multiple memory nodes, and/or multiple storage nodes) networked together within a scalable distributed computing system. Additionally, the computing system 102 may have additional hardware components not shown in FIG. 1. The client devices 104 may include similar architectures.

The computing system 100 may be configured to store historical transaction data 118. The historical transaction data 118 may include past sales transactions between sellers and purchasers. The transactions may include a variety of data related to any number of transactions between any number of sellers and purchasers. As used herein, the term “client” refers to the seller of a product (e.g., a physical good or service) who is using the system 100 to, for example, receive a pricing recommendation for a potential future transaction or identify an optimal pricing strategy for a product. The term “customer” refers to the purchaser or potential purchaser. At least some of the transactions may relate to a good or service purchased in a negotiated transaction or competitive bidding process between the sellers and purchasers. The historical transaction data 118 may also record transactions relating to a wide variety of products, services, industries, geographical areas, companies, customers, clients, etc. The historical transaction data 118 may include several years of transaction data. Each transaction may be represented by a plurality of attributes, including continuous numerical attributes (e.g., quantities, prices, and dates, etc.) and categorical attributes (geography, customer ID, Product ID, product type, etc.).

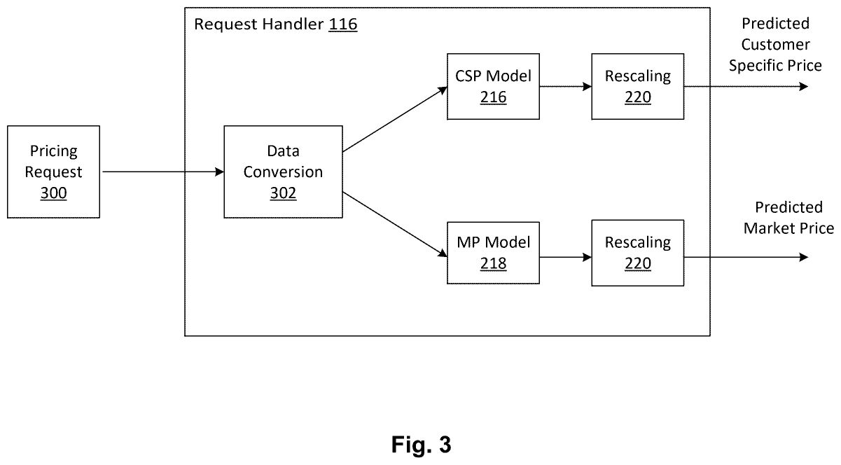

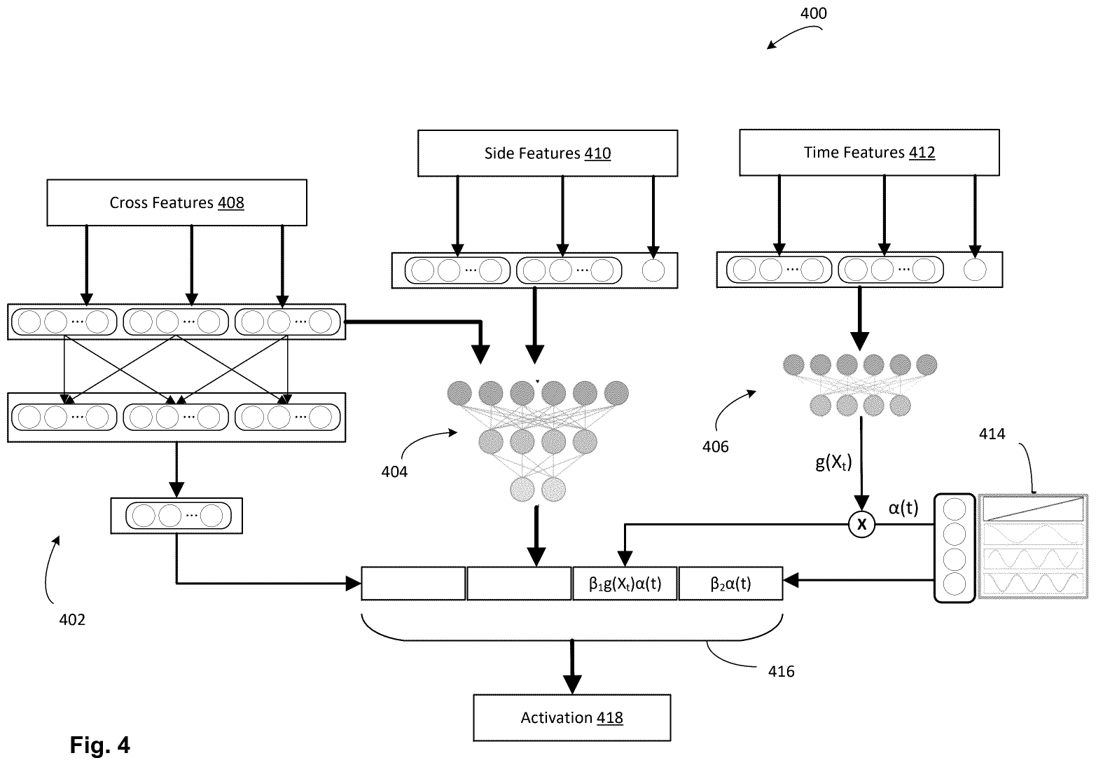

The model trainer 122 is configured to process the historical transaction data 118 to generate a set of training data 120 and use the training data 120 to generate one or more price prediction models 116. The generation of training data may include processing the historical transaction data 118 to clean and validate the data prior to use. Additionally, categorical data may be converted to a numerical vector representation, referred to herein as a vector embedding. Generating the training data 120 may also include generating derived attributes from the historical transaction data 118, including trend attributes, seasonality attributes, and others. Example techniques for generating training data are described further in relation to FIGS. 3 and 4.

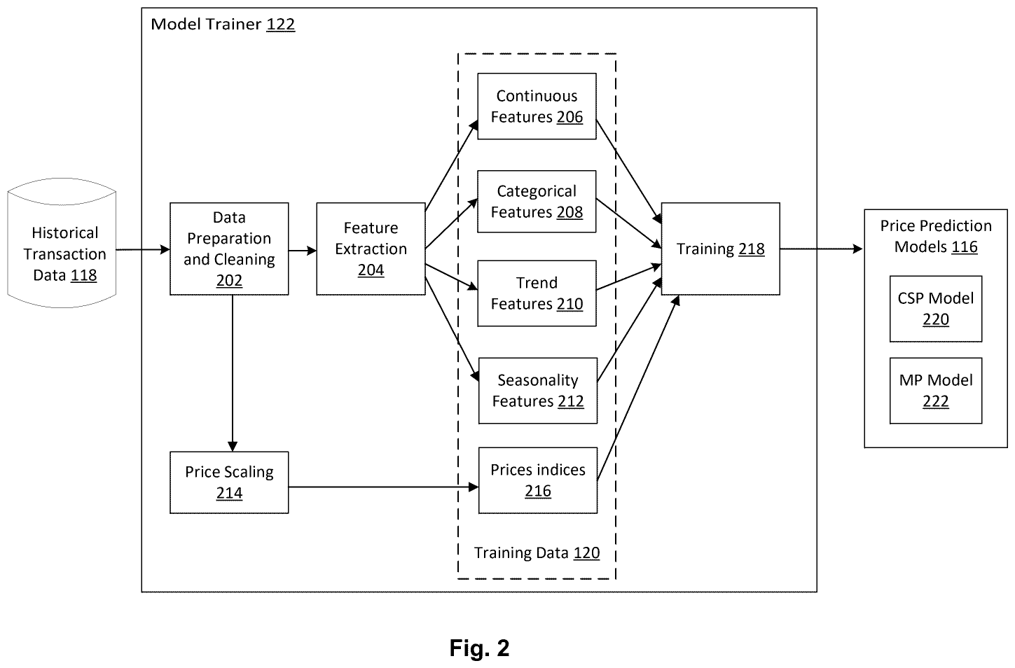

The price predictions models 116 may be any suitable type of artificial intelligence model, machine learning model, artificial neural network, and the like. Each price prediction model 116 may be trained to generate a different type of price prediction. For example, the price prediction models 116 may include a customer-specific price prediction model trained to predict a price that is specific to an identified customer, and a market price model trained to predict a price that is customer agnostic and applicable to the market generally. A more detailed example of a model trainer 122 in accordance with embodiments is shown in FIG. 2. Example techniques for training a price prediction model are described in relation to FIG. 4.

The trained price prediction models 116 may be used to process pricing requests received from the client devices 104. Pricing requests may be received through the user interface 124, which may be a Web server, Application Programming Interface (API), and others. A pricing request may include various information relevant to a potential future transaction, such as a product identifier, product feature information, product cost, number of units to be purchased, transaction date, customer identifier, and others. Pricing requests may be passed to a request handler 126, which is configured to generate pricing recommendations using the trained price prediction models 116.

In response to the pricing request, the client may receive a pricing report that includes the prices returned by the price prediction models 116 and additional information which may be computed based, in part, on the predicted prices. Techniques for processing client pricing requests are described further in relation to FIG. 3. The pricing report may be returned to the client device 104 through the user interface 124 or through another route such as a shared storage device, email delivery, and others.

The training data 120 may be updated as new transaction data is received and added to the historical transaction data 118. For example, the client may report additional transactions periodically or in real time new transactions are performed. The training data 120 may be periodically retrieved by the model trainer 122, which uses the updated training data 120 to update the price prediction models 116. In this way, the price prediction models 116 can be refined over time. It will be appreciated that various alterations may be made to the system 100 and that some components may be omitted or added without departing from the scope of the disclosure.

FIG. 2 is a block diagram of a model training system 200 in accordance with some embodiments of the present disclosure. The model training system 200 includes the model trainer 122, which may include a data preparation and cleaning module 202, a feature extraction module 204, and a training module 211. The model trainer 122 may be implemented in hardware or a combination of hardware a software and any suitable type of computing architecture including distributed computing systems.

As described in relation to FIG. 1, the model trainer 122 processes the historical transaction data 118 to generate the price prediction models 116. Each entry in the historical transaction data 118 may include a set of attributes that capture information relevant to that particular transaction. For example, each entry may include product attributes related to the product involved in the transaction, such as a product identifier, stock keeping unit (SKU), product name, brand, manufacturing cost, color, version, manufacturer's suggested retail price, optional product features such as size, product specifications, and the others. Each entry may also include customer attributes related to the customer involved in the transaction such as a customer business name, customer ID, industry, geographical region in which the customer does business, company size, customer age (e.g., years in business), and others. Each entry may also include transaction attributes related to the transaction itself, such as the date or time of the transaction, a transaction ID, purchase price, product volume (e.g., number of units sold), delivery details (e.g., means, date, location). Any number of additional details may be included.

In some embodiments, the historical transaction data 118 may only record transactions that were successfully executed. In some embodiments, the historical transaction data 118 may also record entries for transactions that are identified as having not been executed (due to losing a bid, for example). The historical transaction data 118 may be stored in the form of one or more databases (e.g., relational database) within storage 112. The historical transaction data 118 may be communicated to the computing system 102 from the client devices 104 and may be regularly updated to ensure that the data is accurate and current.

The historical transaction data 118 is ingested by the data preparation and cleaning module 202, which cleans and validates the data prior to use. For example, the historical transaction data 118 may be processed to correct or eliminate data that appears to be in error, such as statistical outliers or misspellings, for example. The data preparation and cleaning module 202 may also rescale and/or reformat attributes to a consistent scale and format (e.g., same date format, same monetary unit, etc.).

The data preparation and cleaning module 202 may also process the historical transaction data 118 to generate additional attributes referred to herein as derived attributes. Derived attributes may include customer annual spend, customer growth, trend and seasonality attributes, customer product centricity, customer purchase frequency, customer revenue (overall and per product), and other metrics such as price/price index, margin percent, and others.

The cleaned and prepared data may then be processed by the feature extraction module 204 to generate the training data 120, which includes features that serve as the input to a neural network. Each feature may be a numerical representation that is generated from one or more of the attributes.

The features may include continuous features 206, categorical features 208, trend features 210, and seasonality features 212. Continuous features 206 are features that represent continuous numerical attributes such as quantities, prices, and dates. Continuous features 206 may be generated by normalizing continuous attributes to a value within the specified range. Various feature scaling techniques may be used to normalize the data, including min-max normalization, mean normalization, and others.

Categorical features are features that represent categorical attributes such as geography, customer ID, and Product ID. Categorical features may be generated using a vector embedding technique, which is able to convert textual information to a vector representation, i.e., n-dimensional vector with an array of n elements, where each element is a number with a value within a specified range between a minimum and maximum value (e.g., between 0 and 1). In vector embedding, the degree of similarity between any two vectors reflects the degree of similarity between the underlying attributes. Thus, the vector embeddings are able to capture semantic relationships and similarities in the categorical attributes. For example, vectors generated for the attributes “Dallas” and “Houston” would be expected to be relatively similar compared a vector generated for the attribute “New York.” In this way, similar categorical attributes will tend to produce similar categorical features and have a similar effect on the price prediction model.

Trend features are features that reflect any long-term price changes over time that are not a result of seasonal effects (e.g., inflation). In some embodiments, trends are captured by using a time measurement such as day number or week number as a trend feature.

Seasonality features are features that reflect price changes that occur periodically from year to year. In some examples, seasonality features may be captured by using a Fourier series filter as a seasonality feature. The Fourier series filters may be used to extract specific frequency components from the historical price data. Any number of Fourier series filters may be designed to identify and extract periodic pricing fluctuations that tend to occur at certain specified intervals, such as weekly, monthly, quarterly, yearly, and others. Some seasonality features may be more detectable if 1.5 years or more of historical pricing data is available.

As noted above, the price prediction models are generated without segmentation. Accordingly, the training data 120 is not segmented by customer, customer size (e.g., average annual revenue), product type, geography, of any other transaction attribute.

In order to train the price prediction models 116 to be generally applicable across a diverse range of transactions, the transaction prices are scaled to generate a price index for each transaction. In this way, the price information can be represented in a uniform way across a broad range of different transactions. Accordingly, the cleaned and prepared data may also be processed by a price scaling module 214 to generate price indices 216 used in the training data 120. To generate the price index, the transaction price may first be converted to a unit price, which is the price per unit for the transaction (e.g., transaction price divided by the transaction quantity=unit price). The transaction-specific unit price may then be scaled by dividing the unit price by a normalizing value, which may vary depending on the business context. In some embodiments, the average unit price of the product across a plurality of transactions is used as the normalizing factor. In this case, the transaction's price per unit would be divided by the product's average price per unit to generate the price index.

The training data 120 may be divided into a number of training samples, each of which has an input and a corresponding output that corresponds with a specific historical transaction. The training sample input includes the features derived from the attributes of a specific transaction and the training sample output is the transaction's corresponding price index, which serves as the desired output. Some of the training data may also be used as testing data, which is used for a validation phase of the training algorithm. The training samples and testing samples may be divided into several batches.

In some embodiments, the training module 218 may be used to train an artificial neural network (ANN) to create a mapping between the attributes of a transaction and the price index for the transaction. The mapping may then be used to generate a predicted price using the attributes of a potential future transaction. The predicted price may represent an estimate of the price that customers would pay for a potential future transaction if the historical pricing policy is followed.

To generate the neural network, values for the hyperparameters of the neural network may be specified. The hyperparameters may be any parameters that affect the structure of the neural network, such as the number of hidden layers and the number of neurons in each hidden layer, or determine how the neural network is trained, such as the learning rate and batch size, among others. In some embodiments, the hyperparameters may be iteratively adjusted by the model trainer 122.

Training the neural network means computing the values of the neural network's weights and biases to minimize an objective function that characterized the difference between the neural network's output and the desired output. The training process is an iterative process where, at each iteration, the neural network is fed a training sample input and an output is obtained at the output layer of the neural network. The loss function consists of terms that can be calculated based on a comparison of the neural network's output and the corresponding training sample's price index, which is used as the desired output. For example, the loss function may be a Mean-Squared Error (MSE) function, which may be expressed as follows:

$$\\ Loss = \frac{Sum ( {( Actual - Prediction )}^{2} )}{N}$$

The term Actual in the above function represents the desired output and the term Prediction represents the neural network's output. The Mean-Squared Error measures the average of the squares of the errors or deviations. It is more sensitive to large errors due to the squaring process. The loss function may also be a Mean-Absolute Error (MAE) function as shown below:

$$Loss = Sum ( \vert Actual - Prediction \vert ) / N$$

Mean Absolute Error (MAE) measures the average of the absolute errors between the actual and predicted values. It is less sensitive to outliers compared to MSE. Other types of loss functions may be used, including quantiles loss, which is generalizations of MAE, and others. Embodiments of the present techniques are not limited to the specific loss functions described herein, but may be implemented using any suitable loss function including those described herein or others. The neural network may be a feedforward neural network trained using any suitable training algorithm, including backpropagation, a gradient descent algorithm, and/or a mini-batch technique.

The process of adjusting the hyperparameters of the network iteratively to minimize training errors is called hyper parameter tuning. For hyperparameter tuning, the training data 120 is divided into a training set and validation set. Hyperparameter tuning in a neural network involves systematically searching through a range of hyperparameter values to find the combination that results in the least error between the predictions generated by the model and the actual observations. This process is crucial for optimizing the neural network's accuracy and efficiency. Key hyperparameters include learning rate, batch size, number of layers, number of neurons per layer, and activation functions. Techniques such as grid search, random search, or Bayesian optimization are employed to explore the hyperparameter space. During this process, each set of hyperparameters is used to train the network, and its performance is evaluated on the validation dataset. The goal is to identify the hyperparameters that minimize a predefined loss function or maximize accuracy, ensuring the model generalizes well to new, unseen data. This systematic approach is essential for enhancing the neural network's predictive capabilities, making it a critical step in the development of robust and effective machine learning models.

As shown in FIG. 2, the training module 218 may be used to train two price prediction models, a customer-specific price model 220 configured to predict a price for a specific customer, and a market price model 222 used to predict a market price that applies to the market a whole. Each price prediction model may use a same model architecture and training algorithm but are trained separately using different training data. For example, the customer-specific price model 220 may be trained using customer-specific attributes such as customer ID, last price paid by the customer, and others. By contrast, the market price model 220 may be trained without using customer-specific attributes. For the market price model, customer-specific attributes such as customer ID and last price paid by the customer are not used for training. It should be noted that both the customer-specific price model and the market price model are trained using historical transaction data applicable to a plurality of customers. Accordingly, the customer-specific price model will still capture overall market influences on price even though it is trained to provide a price prediction that is customer specific. Training the customer-specific price model using transaction data from a plurality of customers avoids data sparsity and eliminates the need to generate a different model for each customer.

Additionally, although two price predictions models are shown, embodiments of the present techniques may be implemented in a single model that provides both price predictions. In such embodiments, there would only be a single training data set, but some internal parts of the neural network that are used to create the market price prediction would receive a subset of features, while parts of the neural network that are used to create the customer-specific price prediction would receive all of the features.

FIG. 3 is a block diagram of a request handler 116 in accordance with some embodiments of the present disclosure. The model trainer 122 may be implemented in hardware or a combination of hardware a software and any suitable type of computing architecture including distributed computing systems. As described above in relation to FIG. 1, the request handler is configured to generate pricing recommendations using the trained price prediction models 116. In the example embodiment shown in FIG. 3, the price prediction models 116 include the customer-specific model 220 and the market price model 222.

The pricing request 300 may include a number of attributes that are relevant to a potential future transaction, such as product ID, customer ID, customer annual revenue, customer geography, customer size, transaction date, etc. The request attributes are ingested by the data conversion module 302 to generate the input to the price prediction models. The data conversion module 302 converts the attributes to a form suitable for the neural network using the same process described above for the feature extraction module 204. Specifically, continuous attributes are converted to continuous features using the same feature scaling technique, and categorical attributes are converted to categorical features using the same vector embedding technique.

The converted data is then input to the price prediction models. The input to the customer-specific price model 220 will include features that are customer-specific (e.g., customer ID, last price paid by the customer, etc.) and features that are not customer-specific (e.g., product ID, geography, etc.). By contrast, the input to the market price model will include not include customer-specific features, so features such as customer ID will not be included as input to the market price model.

The output of the customer-specific price model 220 is a customer-specific price index, and the output of the market price model is a predicted market price index. The price index output by each model will be in this same scale space as the price indices used to train the models. Accordingly, both of these prices may be upscaled using the inverse normalization operation that was used to scale the prices as described in relation to FIG. 2, resulting in an actual price denominated in the appropriate currency (e.g., an actual dollar amount). For example, the price index may be rescaled by multiplying the resulting price index by the average price per unit. These prices may be returned to the client as a price recommendation that may serve as a guide to determine an actual offer price for use in a negotiated transaction.

In some examples, the predicted customer price and/or the predicted market price generated by the system may be used as input to additional pricing models that can provide additional pricing information. For example, if the client has confidence in the customer relationship or the skill of the salesperson or team conducting the negotiation, the client may decide that a higher price is justifiable. The degree to which the client is willing to deviate from the price recommendation will also depend on the price elasticity relevant to the particular transaction (the specific customer, product, etc.). In some embodiments, the price recommendations may be used to generate a win rate curve, which provides an estimate for the probability of winning a particular transaction over a range of prices. The client cost and the win rate curve may generate an expected profit curve that indicates a more effective price for maximizing profit over a number of transactions. In some embodiments, feature importance scores may be generated for each of the features input to the model. A feature importance score is a value that indicates which features affected the price output by the model and the relative influence that each feature had on the price. Feature importance scores may be generated using Shapley values, for example. The predicted prices, win rate curve, expected profit curve, feature importance scores may be delivered to the client in the form of a price recommendation report.

FIG. 4 is an illustration of an example a price prediction model in accordance with some embodiments of the present disclosure. The price prediction model 400 may represent both the customer-specific price model 220 and the market price model 222, each of which may have the same general architecture but use different input features for training and computing price predictions, as described above. It will be appreciated that the price prediction model 400 of FIG. 4 is only one example of an architecture that can be used to implement the techniques disclosed herein and that various other architectures may be used. For example, the price prediction model could be a single deep neural network with a few densely coupled layers, such as a Multilayer Perceptron (MLP), and others.

The example price prediction model 400 includes a neural network composed of three parallel subnetworks: a cross network 402, a deep neural network 404, and a time network 406. The output of each subnetwork is provided to the output layer 416. The final price prediction is calculated by concatenating the outputs from all these subnetworks and passing it to the activation function 418. The inputs to the cross network 402 are referred to as cross features 408, the inputs to the deep neural network 404 that are not also input to the cross network 402 are referred to as side features 410, and inputs to the time network 406 as time features 412. In FIG. 4, the three subnetworks are shown with a particular number of layers and nodes per layer. However, it will be appreciated that these are merely exemplary illustrations and that embodiments of the present techniques are not limited to these specific configurations.

Cross features 408, side features 410, and time features 412 are subsets of the features used in the input data. Determining which features are used as cross features 408, which as side features 410, and which as time features 412 may be determined by expert knowledge of the expected dependencies between different attributes. Examples of features used in the Neural Network may include customer ID, customer annual revenue, product ID, product brand, geography, quantity (e.g., number of units sold), and more. Depending on the use case, some of these features would be cross-features 408, some side features 410, and others time features 412.

The cross network 402 enables the price prediction model 400 to capture feature interactions that have a significant effect on prices. For example, the brand of a product involved in a transaction may have a different effect on prices depending on the city involved in the transaction. Additionally, the customer ID of a transaction may have a different effect on prices depending on the product ID. The cross network 402 enables the model to automatically learn these important feature interactions and their effect on prices. As used herein, the term “cross feature” refers to those features whose effect on the price varies depending on the values of other features. In this example, all of the cross features 408 are categorical features that have been converted to vectors using a vector embedding technique as described above in relation to FIG. 2. Each cross feature 408 is input to one of the input nodes of the cross network 402. Each cross feature 408 is then multiplied by each of the other cross features 408 to produce an element-wise product of the vectors, known as the Hadamard product. The output of the cross network 402 is the sum of all of the Hadamard products, and this output is provided to the output layer 416 of the price prediction model 400.

The cross features 408 are also used as input to the deep neural network 404, in addition to the side features 410. Side features 410 are features whose feature interactions have a less significant interaction effect on prices compared to cross features. Stated differently, cross features are features that exhibit more significant feature interactions compared to the side features. Side features 410 can interact with the other features within the deep neural network 404, which can handle that. However, the price prediction model 400 can pick up feature interactions more easily when they are explicitly modeled as cross features 408 using the cross network 402.

In the example model shown in FIG. 4, time dependency is modeled at both global and local levels. The global level model captures the seasonality and trend across all the data, while the local time model can capture trends and seasonality for each value of the time features 412 using the time features 412. If no time features 412 are configured by the user, then the same seasonality and trend models are shared by all feature combinations, while the local time model implemented through the time network 406 enables greater flexibility to capture seasonality and trend effects of specific features.

Time features 412 are the features that exhibit a greater time-dependent effect on prices due to trend or seasonality effects. The time features 412 determine the level of the trend and seasonality terms at the output layer 416 of the price prediction model 400. Any of the input features can be used as a time feature. There can be a unique trend and seasonality model for each value of the time features 412. For example, for clothes, the product category (e.g., shorts, T-shirts, boots, coats, etc.) would be time-dependent because coats are expected to have very different seasonality compared to shorts. Coats may have a high demand in winter while a lower demand in summer, whereas shorts may have a high demand in summer and a lower demand in winter. Hence, in this case, the product category attribute may be selected as a time feature. It will be appreciated that the time features 412 may be a subset of any of the cross features 408 or side features 410. In other words, the features used as time features 412 may also be input to the price prediction model 400 as cross features 408 and/or side features 410.

A linear function along with a series of Fourier functions (referred to as trend features 210 and seasonality features 212 in FIG. 2) are used to capture trend and seasonality effects on prices. These functions can be referred to as time functions and may be provided by the time function generator 414, which generates the time functions responsive to a time input 420 that relates to the time of the transaction. The function generator 414 takes week or date of the transaction as input and converts them to linear trend (linear function) and sine and cosine functions (seasonality functions), together referred to as time functions. The output of the time network 406 (represented as g(Xₜ)) is multiplied by the time functions (represented as α(t)) to capture the local time effect, and the resulting product is output to the last layer 416 of the price prediction model 400. The time functions, α(t), are also passed directly to the last layer 416 to model the global level seasonality.

The output of the cross network 402, deep network 404, time network 406, and the time function generator 414 are concatenated in the output layer 416 and passed to an activation function 418 to produce the final price prediction. The prediction will be in the same scale space as the price indices used to train the price prediction model 400.

During model training, the computed price predictions may be compared to the actual prices using an objective function, and the result used to determine adjustments to be applied to the weights and biases of the neural networks 404 and 406.

It will be appreciated that various alterations may be made to the price prediction model 400 described above and that some components may be omitted or added without departing from the scope of the disclosure.

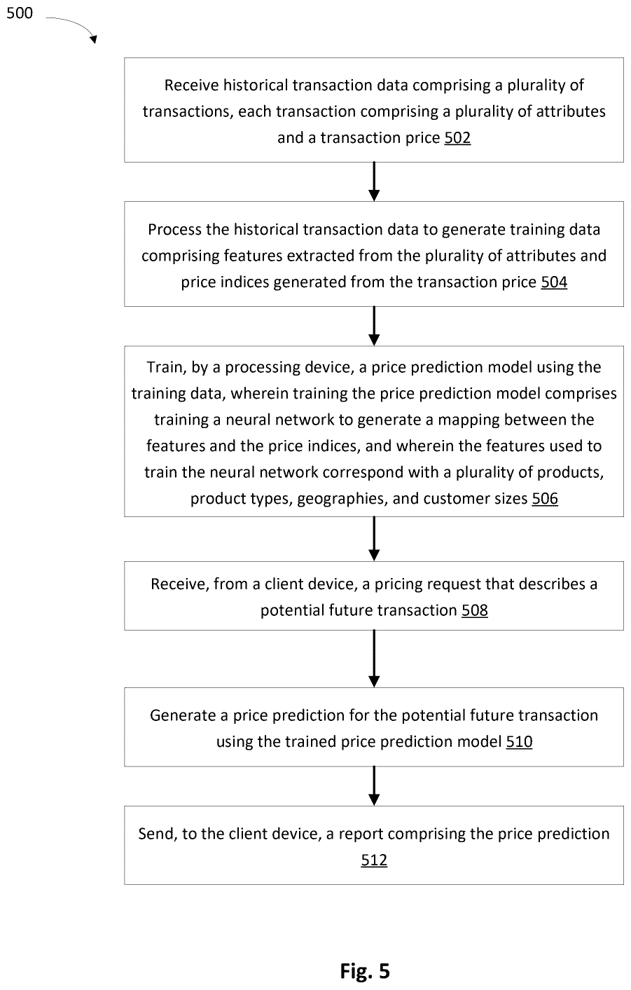

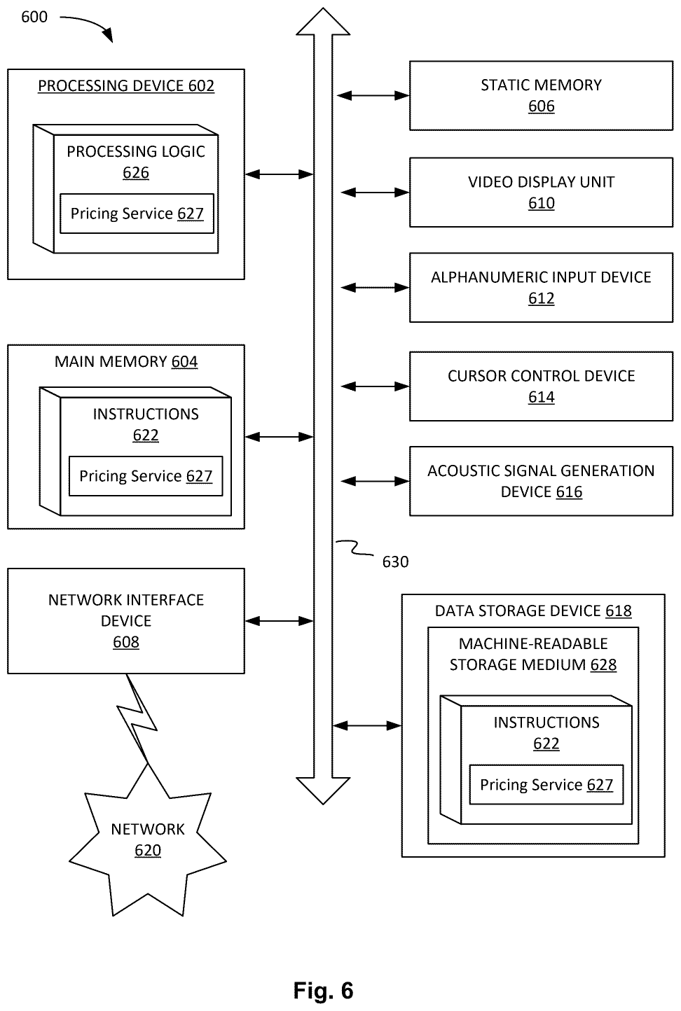

FIG. 5 is a process flow diagram summarizing a method of generating price predictions without data segmentation, in accordance with some embodiments of the present disclosure. Method 500 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 500 may be performed by the computing system 102 of FIG. 1 or the pricing service 627 shown in FIG. 6. The method may begin at block 502.

At block 502, historical transaction data including a plurality of transactions is received, each transaction comprising a plurality of attributes and a transaction price. At block 504, the historical transaction data is processed to generate training data comprising features extracted from the plurality of attributes and price indices generated from the transaction price. The features may include any of the feature types described herein, including cross features, side features, and time features. Categorical features may be extracted using a vector embedding technique that converts the categorical attributes to vector representations that capture semantic relationships and similarities between the categorical attributes. The price indices may be computed by converting the transaction price to a unit price that describes a price per unit of a product identified in the transaction, and then scaling the unit price by a normalizing value, such as an average unit price of the product across the plurality of transactions.

At block 506, a price prediction model is trained using the training data, wherein training the price prediction model includes training a neural network to generate a mapping between the features and the price indices, and wherein the features used to train the neural network correspond with a plurality of products, product types, geographies, and customer sizes. In other words, the training data used to train the price prediction model is not segmented.

At block 508, a pricing request that describes a potential future transaction is received from a client device.

At block 510, a price prediction for the potential future transaction is generated using the trained price prediction model. The price prediction may be a predicted market price or a predicted customer-specific price. In some embodiments, the price prediction model may generate both a predicted market price and a predicted customer-specific price.

At block 512, a report including the price prediction is sent to the client device. The report may also include a variety of additional information, some of which may be derived using the price prediction.

It will be appreciated that embodiments of the method 500 may include additional blocks not shown in FIG. 5 and that some of the blocks shown in FIG. 5 may be omitted. Additionally, the processes associated with blocks 502 through 508 may be performed in a different order than what is shown in FIG. 5.

FIG. 6 illustrates a diagrammatic representation of a machine in the example form of a computer system 600 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a web appliance, a server, and other machines capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 600 may be representative of a server, such as a cloud server, configured as a platform for training neural networks and operating a price prediction system.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618, which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute processing logic 626 for performing the operations and steps discussed herein. For example, the processing logic 626 may include logic for performing the functions of a pricing service 627, which may include the model trainer 122, the request handler 126, and any of the other components described above in FIGS. 1-4.

The data storage device 618 may include a machine-readable storage medium 628, on which is stored one or more set of instructions 622 (e.g., software) embodying any one or more of the methodologies of functions described herein, including instructions to cause the processing device 602 to perform the functions of the pricing service 627. The instructions 622 may also reside, completely or at least partially, within the main memory 604 or within the processing device 602 during execution thereof by the computer system 600; the main memory 604 and the processing device 602 also constituting machine-readable storage media. The instructions 622 may further be transmitted or received over a network 620 via the network interface device 608.

While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “configuring,” “training,” “identifying,” “transmitting,” “sending,” “storing,” “detecting,” “processing,” “generating” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving historical transaction data comprising a plurality of transactions, each transaction comprising a plurality of attributes and a transaction price;
processing the historical transaction data to generate training data comprising features extracted from the plurality of attributes and price indices generated from the transaction price;
training, by a processing device, a price prediction model using the training data, wherein training the price prediction model comprises training a neural network to generate a mapping between the features and the price indices, and wherein the features used to train the neural network are not segmented and correspond with a plurality of products, product types, geographies, and customer sizes;
receiving, from a client device, a pricing request that describes a potential future transaction;
generating a price prediction for the potential future transaction using the trained price prediction model; and
sending, to the client device, a report comprising the price prediction.

2. The method of claim 1, wherein at least some of the features are categorical features extracted from categorical attributes of the plurality of attributes using a vector embedding technique that converts the categorical attributes to vector representations that capture semantic relationships and similarities between the categorical attributes.

3. The method of claim 1, wherein generating the price indices comprises, for each transaction:
converting the transaction price to a unit price that describes a price per unit of a product identified in the transaction; and
scaling the unit price by a normalizing value.

4. The method of claim 3, wherein the normalizing value is an average unit price of the product across the plurality of transactions.

5. The method of claim 1, wherein the features comprise cross features and side features, wherein the cross features are features that exhibit more significant feature interactions compared to the side features, and wherein the price prediction model comprises:
a deep neural network trained using the cross features and the side features; and
a cross network trained using only cross features.

6. The method of claim 1, wherein the price prediction model comprises:
a deep neural network trained using the features; and
a time network trained using time features, wherein the time features are a subset of the features that exhibit a greater time-dependent effect on prices due to trend or seasonality effects.

7. The method of claim 6, further comprising multiplying an output of the time network by one or more time functions to capture the trend and seasonality effects of the subset of the features.

8. The method of claim 7, further comprising passing the time functions directly to the last layer of the price prediction model to capture the seasonality and trend across all of the features.

9. The method of claim 1, wherein the price prediction model comprises three parallel subnetworks that each provide an output to a last layer of the price prediction model, the method further comprising passing the last layer of the price prediction model to an activation function to generate the price prediction.

10. The method of claim 1, wherein the price prediction is a predicted market price or a predicted customer-specific price.

11. A system comprising:
a memory; and
a processing device, operatively coupled to the memory, the processing device to:
receive historical transaction data comprising a plurality of transactions, each transaction comprising a plurality of attributes and a transaction price;
process the historical transaction data to generate training data comprising features extracted from the plurality of attributes and price indices generated from the transaction price;
train a price prediction model using the training data, wherein to train the price prediction model comprises to train a neural network to generate a mapping between the features and the price indices, and wherein the features used to train the neural network are not segmented and correspond with a plurality of products, product types, geographies, and customer sizes.

12. The system of claim 11, wherein at least some of the features are categorical features extracted from categorical attributes of the plurality of attributes using a vector embedding technique that converts the categorical attributes to vector representations that capture semantic relationships and similarities between the categorical attributes.

13. The system of claim 11, wherein to generate the price indices comprises, for each transaction, to:
convert the transaction price to a unit price that describes a price per unit of a product identified in the transaction; and
scale the unit price by a normalizing value, wherein the normalizing value is an average unit price of the product across the plurality of transactions.

14. The system of claim 11, wherein the features comprise cross features and side features, wherein the cross features are features that exhibit more significant feature interactions compared to the side features, and wherein the price prediction model comprises:
a deep neural network trained using the cross features and the side features; and
a cross network trained using only the cross features.

15. The system of claim 11, wherein the price prediction model comprises:
a deep neural network trained using the features; and
a time network trained using time features, wherein the time features are a subset of the features that exhibit a greater time-dependent effect on prices due to trend or seasonality effects.

16. The system of claim 15, wherein the processing device is to multiply an output of the time network by one or more time functions to capture the trend and seasonality effects of the subset of the features.

17. The system of claim 16, wherein the processing device is to pass the time functions directly to the last layer of the price prediction model to capture the seasonality and trend across all of the features.

18. The system of claim 11, wherein the price prediction model comprises three parallel subnetworks that each provide an output to a last layer of the price prediction model, and wherein the processing device is to pass the last layer of the price prediction model to an activation function to generate the price prediction.

19. A non-transitory computer-readable storage medium including instructions that, when executed by a processing device, cause the processing device to:
receive historical transaction data comprising a plurality of transactions, each transaction comprising a plurality of attributes and a transaction price;
process the historical transaction data to generate training data comprising features extracted from the plurality of attributes and price indices generated from the transaction price;
train, by the processing device, a price prediction model using the training data, wherein to train the price prediction model comprises to train a neural network to generate a mapping between the features and the price indices, and wherein the features used to train the neural network are not segmented and correspond with a plurality of products, product types, geographies, and customer sizes.

20. The non-transitory computer-readable storage medium of claim 19, wherein the features comprise cross features, side features, and time features, wherein the cross features are features that exhibit more significant feature interactions compared to the side features, wherein the time features are a subset of the cross features and time features that exhibit a greater time-dependent effect on prices due to trend or seasonality effects, and wherein the price prediction model comprises:
a deep neural network trained using the cross features and the side features; and
a cross network trained using only the cross features; and
a time network trained using the time features.
